(19) United States
(12) Patent Application Publication
(10) Pub. No.: US 2020/0285947 A1
(43) Pub. Date: Sep. 10, 2020

(54) CLASSICAL NEURAL NETWORK WITH SELECTIVE QUANTUM COMPUTING KERNEL COMPONENTS

(71) Applicant: International Business Machines Corporation, Armonk, NY (US)

(72) Inventors: John A. Gunnels, Somers, NY (US); Antonio Corcoles-Gonzalez, Mount Kisco, NY (US); Jay M. Gambetta, Yorktown Heights, NY (US); Lior Horesh, North Salem, NY (US); Paul Kristan Temme, Ossining, NY (US)

(73) Assignee: International Business Machines Corporation, Armonk, NY (US)

(21) Appl. No.: 16/295,764

(22) Filed: Mar. 7, 2019

(51) Int. Cl. G06N 3/063; G06N 10/00; G06N 3/04; G06N 3/08

(52) U.S. Cl. CPC G06N 3/063; G06N 3/08; G06N 3/04; G06N 10/00

(57) ABSTRACT

Implementing a hybrid classical-quantum neural network includes constructing, by at least a first processor, a neural network for classification of input data. The neural network includes a plurality of neural network components. The at least a first processor initiates training of the neural network using training data. The at least a first processor identifies one or more of the plurality of neural network components for replacement. A quantum processor constructs a quantum component corresponding to the one or more network components. The one or more identified neural network components of the neural network are replaced with the quantum component to construct a hybrid classical-quantum neural network.

### TECHNICAL FIELD

The present invention relates generally to neural networks. More particularly, the present invention relates to a system and method for implementing a classical neural network with selective quantum computing kernel components.

### BACKGROUND

Hereinafter, a “Q” prefix in a word of phrase is indicative of a reference of that word or phrase in a quantum computing context unless expressly distinguished where used.

Molecules and subatomic particles follow the laws of quantum mechanics, a branch of physics that explores how the physical world works at the most fundamental levels. At this level, particles behave in strange ways, taking on more than one state at the same time, and interacting with other particles that are very far away. Quantum computing harnesses these quantum phenomena to process information.

The computers we commonly use today are known as classical computers (also referred to herein as “conventional” computers or conventional nodes, or “CN”). A conventional computer uses a conventional processor fabricated using semiconductor materials and technology, a semiconductor memory, and a magnetic or solid-state storage device, in what is known as a Von Neumann architecture. Particularly, the processors in conventional computers are binary processors, i.e., operating on binary data represented by 1 and 0.

A quantum processor (q-processor) uses the unique nature of entangled qubit devices (compactly referred to herein as “qubit,” plural “qubits”) to perform computational tasks. In the particular realms where quantum mechanics operates, particles of matter can exist simultaneously in multiple states-such as an “on” state, an “off” state, and both “on” and “off” states simultaneously. Where binary computing using semiconductor processors is limited to using just the on and off states (equivalent to 1 and 0 in binary code), a quantum processor harnesses these quantum states of matter to output signals that are usable in data computing.

Conventional computers encode information in bits. Each bit can take the value of 1 or 0. These is and Os act as on/off switches that ultimately drive computer functions. Quantum computers, on the other hand, are based on qubits, which operate according to two key principles of quantum physics: superposition and entanglement. Superposition means that each qubit can represent both a 1 and a 0 inference between possible outcomes for an event. Entanglement means that qubits in a superposition can be correlated with each other in a non-classical way; that is, the state of one (whether it is a 1 or a 0 or both) can depend on the state of another, and that there is more information contained within the two qubits when they are entangled than as two individual qubits.

Using these two principles, qubits operate as processors of information, enabling quantum computers to function in ways that allow them to solve certain difficult problems that are intractable using conventional computers.

In machine learning, a classical support vector machine (SVM) is a supervised learning model associated with learning algorithms that classifies data into categories. Typically, a set of training examples are each marked as belonging to a category, and an SVM training algorithm builds a model that assigns new examples to a particular category. An SVM model is a representation of the examples as points in a feature space mapped so that the examples of the separate categories are divided by a gap in the feature space. The feature map refers to mapping of a collection of features that are representative of one or more categories. New input data is mapped into the same feature space and predicted to belong to a category based upon a distance from the new example to the examples representative of a category utilizing the feature map. Typically, an SVM performs classification by finding a hyperplane that maximizes the margin between two classes. A hyperplane is a subspace whose dimension is one less than that of its ambient space, e.g., a three-dimensional space has two-dimensional hyperplanes. A quantum classifier, such as a QSVM, implements a classifier using a quantum processor which has the capability to increase the speed of classification of certain input data.

The illustrative embodiments recognize that classifiers are often implemented utilizing neural networks. The illustrative embodiments further recognize that the performance of neural networks depends upon their ability to form and learn an expressive feature space relevant to input and output spaces. Illustrative embodiments recognize that insufficiencies in feature space representation often result in an inability to distinguish between objects of different classes when attempting to classify input data. Illustrative embodiments further recognize that in some settings, representation of features cannot be attained efficiently using a classical neural network such as with a non-exponentially sized feature space or a reproducing kernel Hilbert space (RHKS).

Embodiments further recognize that the capability of state-of-the-art artificial neural networks to address problems involving complex data may be challenged by multiple factors. One factor may include that of feature space storage when both the data as well as the feature space may become excessively large. Another factor may include that of computation resources in which the computations required for training and simulation associated with neural networks of complex relationships are often a serious bottleneck. Another factor may include that of adaptivity in which there is often a challenge to identify where and how to adapt the feature space so as to provide improved distinction between objects of different classes. Still another factor may include generalizability in which an inefficient feature space representation may require a larger parameter space, which often implies over-fitting and poor generalization of performance.

The illustrative embodiments recognize that a need exists for a novel method for implementing a classical neural network with selective quantum computing kernel components.

### SUMMARY

The illustrative embodiments provide a method, system, and computer program product for implementing a classical neural network with selective quantum computing kernel components. An embodiment of a method for implementing a hybrid classical-quantum neural network includes constructing, by at least a first processor, a neural network for classification of input data, the neural network including a plurality of neural network components. The embodiment further includes initiating, by the at least a first processor, training of the neural network using training data. The embodiment further includes identifying, by the at least a first processor, one or more of the plurality of neural network components for replacement. The embodiment further includes constructing, by a quantum processor, a quantum component corresponding to the one or more network components. The embodiment still further includes replacing the one or more identified neural network components of the neural network with the quantum component to construct a hybrid classical-quantum neural network. Thus, the embodiment provides for implementing a classical neural network with selective quantum computing kernel components to improve classification of data using hybrid classical-quantum neural network.

Another embodiment further includes receiving one or more user defined parameters, wherein the neural network is constructed based upon the one or more user defined parameters. Thus, the embodiment provides for the capability of a user to tailor the structure of the neural network according to requirements of a particular application.

In another embodiment, the quantum component comprises a quantum kernel component. In another embodiment, the quantum kernel component implements a quantum feature space that is equivalent to or provides improved classification performance over a feature space associated with the one or more identified neural network components. Thus, the embodiment provides for replacing a classical neural network component with a quantum component having equivalent functionality to improve computational efficiency during classification of data.

In another embodiment, the one or more neural network components are identified based upon a sensitivity of the one or more neural network components to input data during training. In another embodiment, the one or more neural network components are identified based upon a firing pattern during inference. Thus, the embodiment provides for identification of neural network components to be replaced using sensitivity or firing pattern of the neural network component.

Another embodiment further includes monitoring a performance of the hybrid classical-quantum neural network to determine a quality level of classification results of the hybrid classical-quantum neural network. Another embodiment further includes identifying, responsive to determining that the quality level does not meet a threshold value, one or more other neural network components for replacement. Thus, the embodiment provides for measuring a quality level of classification results produced by the hybrid classical-quantum neural network.

Another embodiment further includes receiving input data, classifying the input data using the hybrid classical-quantum neural network, and outputting a classification result indicative of the determined classification of the input data. Thus, the embodiment provides for improved classification of data using an improved hybrid classical-quantum neural network.

In another embodiment, the at least a first processor comprises a classical processor. In another embodiment, the neural network comprises a classical neural network.

In an embodiment, the method is embodied in a computer program product comprising one or more computer-readable storage devices and computer-readable program instructions which are stored on the one or more computer-readable tangible storage devices and executed by one or more processors.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIGS. 3A-3C depict s simplified example sequence for replacing components of a classical components of a neural network with quantum computing kernel components in accordance with an illustrative embodiment;

FIG. 4 depicts a block diagram of an example process for training a hybrid classical-quantum neural network in accordance with an illustrative embodiment;

FIG. 5 depicts a block diagram of an adaptive learning process for a classical neural network with a quantum component in accordance with an illustrative embodiment;

FIG. 6 depicts a block diagram of an example quantum SVM gate circuitry for implementing a quantum kernel component in accordance with an illustrative embodiment;

FIG. 7 depicts a simplified diagram of an example quantum processor layout 700 in accordance with an illustrative embodiment;

FIG. 8 depicts a block diagram of an example configuration for implementing a classical neural network with selective quantum computing kernel components in accordance with an illustrative embodiment; and

FIG. 9 depicts a flowchart of an example process for implementing a classical neural network with selective quantum computing kernel components in accordance with an illustrative embodiment.

### DETAILED DESCRIPTION

The illustrative embodiments used to describe the invention generally address and solve the above-described problem of solving insufficiencies in feature space representation in a neural network classifier. The illustrative embodiments provide a method and system for implementing a classical neural network with selective quantum computing kernel components.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior. A feedforward neural network is an artificial neural network where connections between the units do not form a cycle.

A deep neural network (DNN) is an artificial neural network (ANN) with multiple hidden layers of units between the input and output layers. Similar to shallow ANNs, DNNs can model complex non-linear relationships. DNN architectures, e.g., for object detection and parsing, generate compositional models where the object is expressed as a layered composition of image primitives. The extra layers enable composition of features from lower layers, giving the potential of modeling complex data with fewer units than a similarly performing shallow network. DNNs are typically designed as feedforward networks. DNNs are often used for image classification tasks for computer vision in which an object represented in an image is identified and classified.

An embodiment provides for analyzing analyzable properties, such as the sensitivity and response, of components of a classical neural network to determine inaccuracies, inefficiencies, computational hurdles/scaling issues, sensitivity issues and other feature space inadequacies that would indicate that replacement of one or more components of the neural network by an appropriate quantum-based functional unit is beneficial. In an embodiment, sensitivity is used in the course of training/learning. In another embodiment, response/firing pattern is used as an analyzable property during inference. In other embodiments, other qualifiers (e.g., information measures) may be used to score how effective a sub-network is in performing its tasks.

In an embodiment, the classical neural network component is replaced with or duplicated by a quantum component such as a quantum kernel component that is equivalent to the classical neural network component. In some embodiments, the neural network is configured to bifurcate, receive multiple answers, and tamp down the bifurcations with more training to determine when to route to the quantum component and when to route to a classical component.

In an embodiment, a system monitors the hybrid neural network with both classical and quantum components and determines classical component that may be selectively replaced with quantum components. In some embodiments, quantum components may be replaced and/or approximated with classical components per the resource limitations of each modality as the quantum components and classical components are resource limited in different ways.

In an embodiment, feature space extension of a neural network is achieved by modifying network components characterized to be indifferent to input of different classes. In the embodiment, various measures relying upon analysis of information flow and/or sensitivity are used for characterization/identification of classical subnetwork components of the neural network whose feature space can benefit from a quantum feature space enhancement. Once a subnetwork component has been identified, the input and output of the of the subnetwork are “rewired” to a quantum kernelized feature space component implemented by a quantum processor. In the embodiment, the quantum neural network involves parameters that are learnable by the full classical-quantum neural network structure. In particular embodiments, the parameters may include variational settings that may determine the formation of the quantum feature space or other manipulations applied to data.

Another embodiment provides a conventional or quantum computer usable program product comprising a computer-readable storage device, and program instructions stored on the storage device, the stored program instructions comprising a method for improving classification of data using hybrid classical-quantum neural network. The instructions are executable using a conventional or quantum processor. Another embodiment provides a computer system comprising a conventional or quantum processor, a computer-readable memory, and a computer-readable storage device, and program instructions stored on the storage device for execution by the processor via the memory, the stored program instructions comprising a method for improving classification of data using a hybrid classical-quantum neural network.

Although various embodiments are described as being applicable to classifiers, it should be understood that the principles described herein may be applied to regressors performing regression for non-discrete and/or a continuous set of values.

For the clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or component that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for improving neural network classification using a variety of components that can be purposed or repurposed to provide a described function within a data processing environment, and such adaptations are contemplated within the scope of the illustrative embodiments.

The illustrative embodiments are described with respect to certain types of steps, applications, classical processors, quantum processors, quantum states, classical feature spaces, quantum feature spaces, neural networks, and data processing environments only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

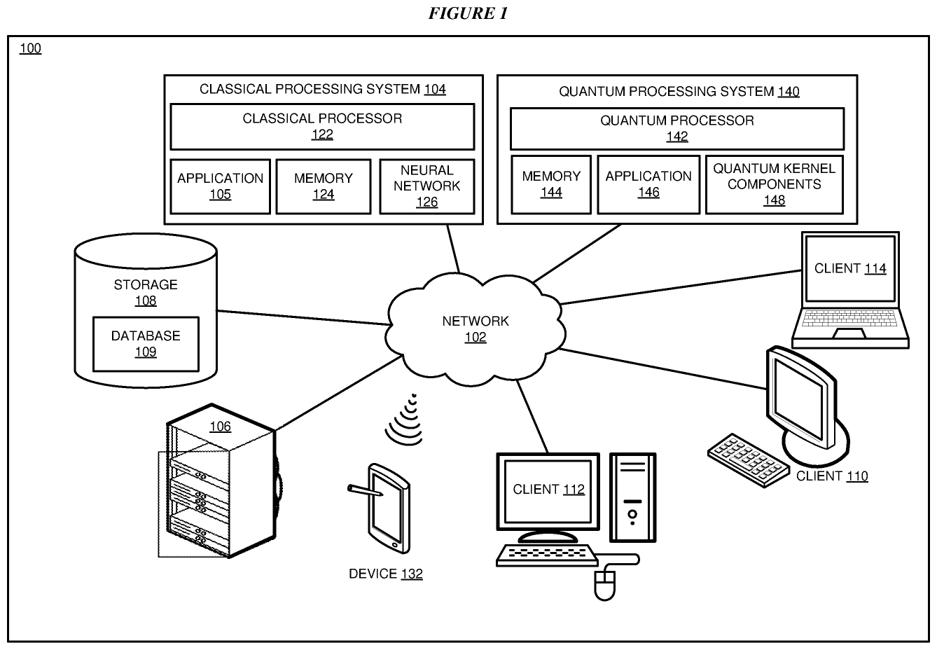

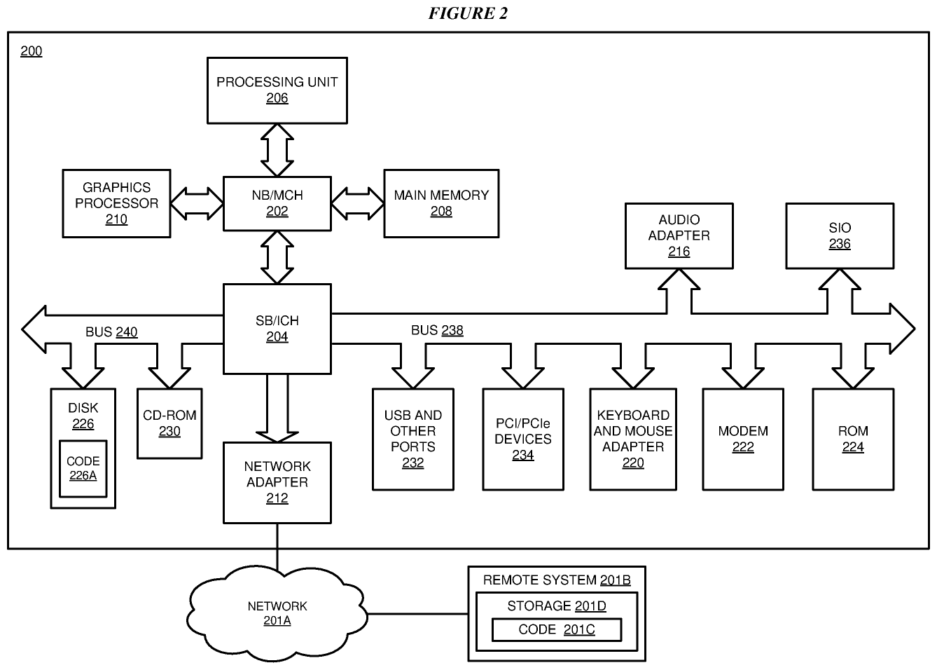

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Classical processing system 104 couples to network 102. Classical processing system 104 is a classical processing system. Software applications may execute on any quantum data processing system in data processing environment 100. Any software application described as executing in classical processing system 104 in FIG. 1 can be configured to execute in another data processing system in a similar manner. Any data or information stored or produced in classical processing system 104 in FIG. 1 can be configured to be stored or produced in another data processing system in a similar manner. A classical data processing system, such as classical processing system 104, may contain data and may have software applications or software tools executing classical computing processes thereon.

Server 106 couples to network 102 along with storage unit 108. Storage unit 108 includes a database 109 configured to store classifier training data as described herein with respect to various embodiments. Server 106 is a conventional data processing system. Quantum processing system 140 couples to network 102. Quantum processing system 140 is a quantum data processing system. Software applications may execute on any quantum data processing system in data processing environment 100. Any software application described as executing in quantum processing system 140 in FIG. 1 can be configured to execute in another quantum data processing system in a similar manner. Any data or information stored or produced in quantum processing system 140 in FIG. 1 can be configured to be stored or produced in another quantum data processing system in a similar manner. A quantum data processing system, such as quantum processing system 140, may contain data and may have software applications or software tools executing quantum computing processes thereon.

Clients 110, 112, and 114 are also coupled to network 102. A conventional data processing system, such as server 106, or client 110, 112, or 114 may contain data and may have software applications or software tools executing conventional computing processes thereon.

Only as an example, and without implying any limitation to such architecture, FIG. 1 depicts certain components that are usable in an example implementation of an embodiment. For example, server 106, and clients 110, 112, 114, are depicted as servers and clients only as example and not to imply a limitation to a client-server architecture. As another example, an embodiment can be distributed across several conventional data processing systems, quantum data processing systems, and a data network as shown, whereas another embodiment can be implemented on a single conventional data processing system or single quantum data processing system within the scope of the illustrative embodiments. Conventional data processing systems 106, 110, 112, and 114 also represent example nodes in a cluster, partitions, and other configurations suitable for implementing an embodiment.

Device 132 is an example of a conventional computing device described herein. For example, device 132 can take the form of a smartphone, a tablet computer, a laptop computer, client 110 in a stationary or a portable form, a wearable computing device, or any other suitable device. Any software application described as executing in another conventional data processing system in FIG. 1 can be configured to execute in device 132 in a similar manner. Any data or information stored or produced in another conventional data processing system in FIG. 1 can be configured to be stored or produced in device 132 in a similar manner.

Server 106, storage unit 108, classical processing system 104, quantum processing system 140, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 106 may provide data, such as boot files, operating system images, and applications to clients 110, 112, and 114. Clients 110, 112, and 114 may be clients to server 106 in this example. Clients 110, 112, 114, or some combination thereof, may include their own data, boot files, operating system images, and applications. Data processing environment 100 may include additional servers, clients, and other devices that are not shown.

In the depicted example, memory 124 may provide data, such as boot files, operating system images, and applications to classical processor 122. Classical processor 122 may include its own data, boot files, operating system images, and applications. Data processing environment 100 may include additional memories, quantum processors, and other devices that are not shown. Memory 124 includes application 105 that may be configured to implement one or more of the classical processor functions described herein for implementing a classical neural network with selective quantum computing kernel components in accordance with one or more embodiments. Memory 124 further includes a classical neural network 126 configured to function as a classifier.

In the depicted example, memory 144 may provide data, such as boot files, operating system images, and applications to quantum processor 142. Quantum processor 142 may include its own data, boot files, operating system images, and applications. Data processing environment 100 may include additional memories, quantum processors, and other devices that are not shown. Memory 144 includes application 146 that may be configured to implement one or more of the quantum processor functions described herein in accordance with one or more embodiments. Quantum processing system 140 further includes quantum kernel components 148 configured to replace one or more classical components of neural network 126 with a quantum kernel component as further described herein.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a conventional client data processing system and a conventional server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a conventional computer, such as classical processing system 104, server 106, or clients 110, 112, and 114 in FIG. 1, or another type of device in which computer usable program code or instructions implementing the processes may be located for the illustrative embodiments.

Data processing system 200 is also representative of a conventional data processing system or a configuration therein, such as conventional data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

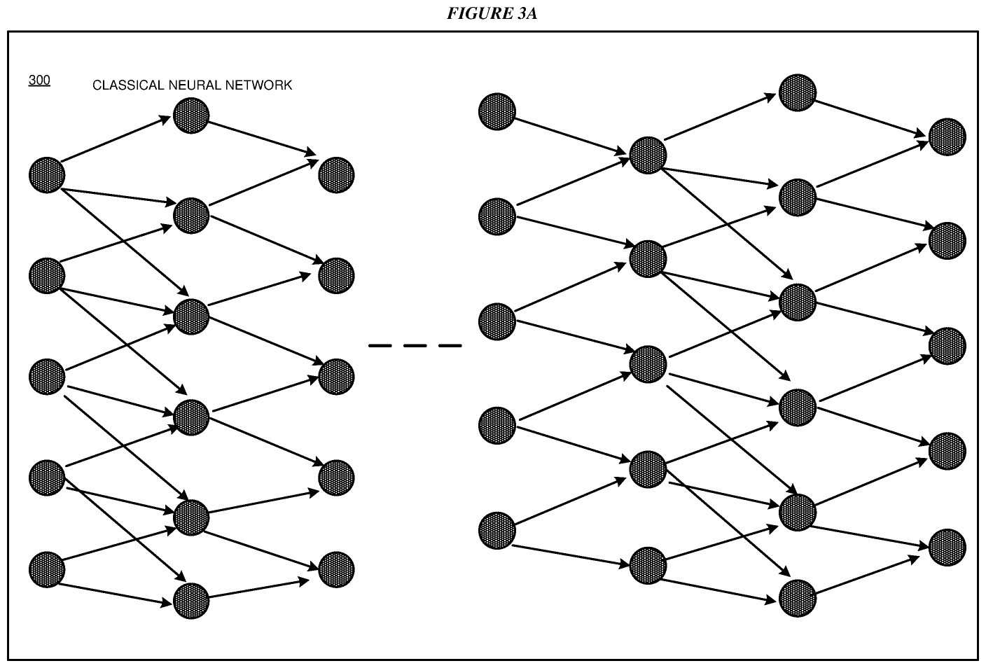

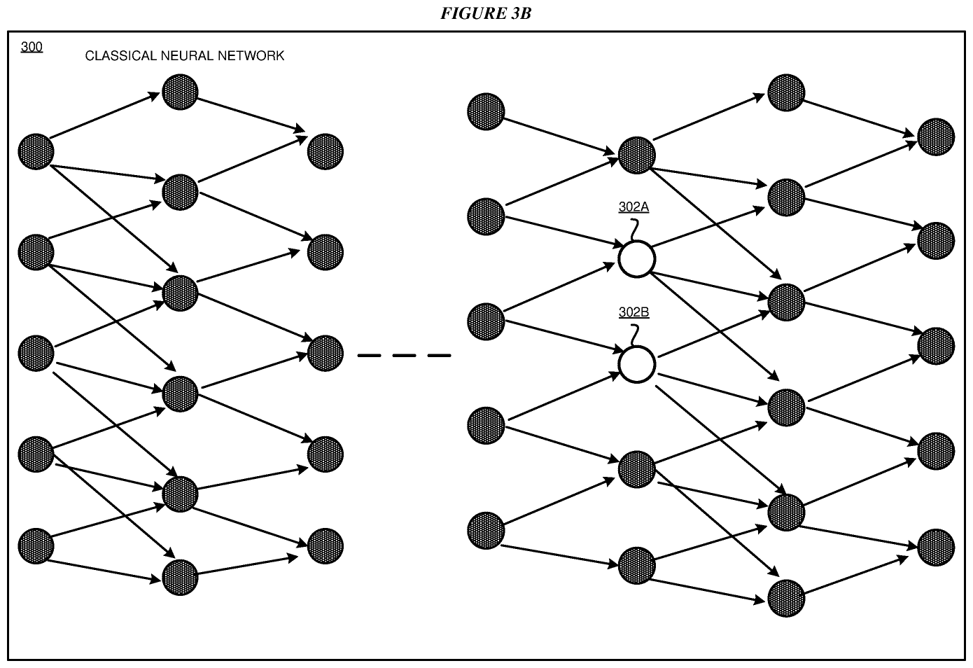

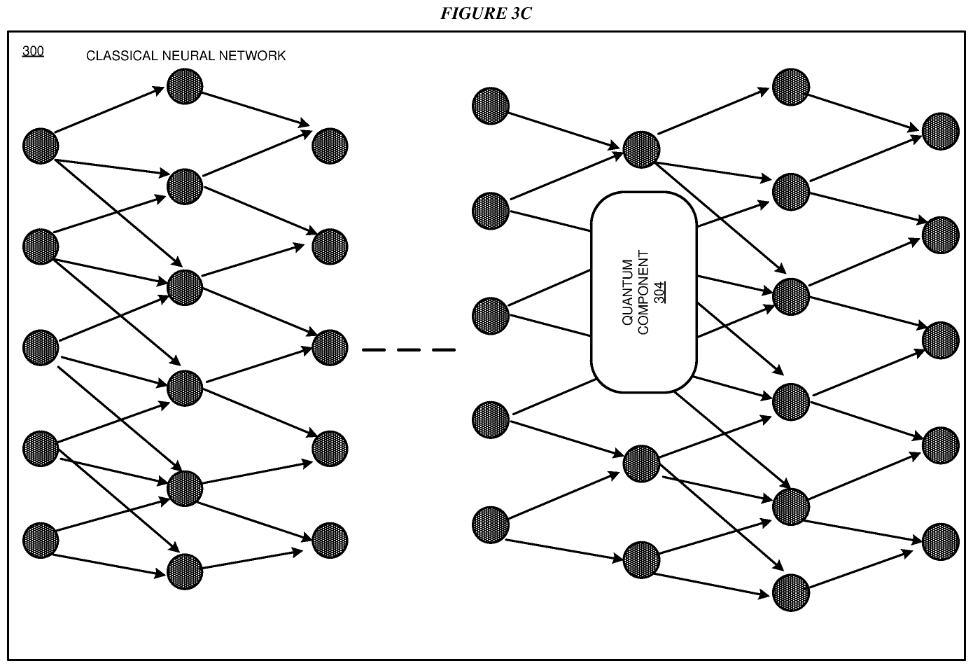

With reference to FIGS. 3A-3C, these figures depict s simplified example sequence for replacing components of a classical components of a neural network 300 with quantum computing kernel components in accordance with an illustrative embodiment. FIG. 3A illustrates an initial state of a neural network 300 formed of a classical neural network having a number of nodes interconnected in a plurality of layers including an input layer, an output layer, and a number of hidden layers of nodes between the input layer and the output layer. In one or more embodiments, the classical neural network is implemented by a classical computer such as classical processing system 104.

FIG. 3B illustrates identifies a subnetwork component for quantum feature enhancement by determining that a component including a first classical neural node 302A and a second classical neural node 302B of neural network 300 is suitable for replacement by a quantum component such as a quantum kernel component. FIG. 3C illustrates replacement of first classical neural node 302A and second classical neural node 302B with a quantum component 304 such as a quantum kernel component to produce a hybrid classical-quantum neural network for classification of input data. In one or more embodiments, quantum component 304 is implemented by a quantum processor such as quantum processor 142 of quantum processing system 140.

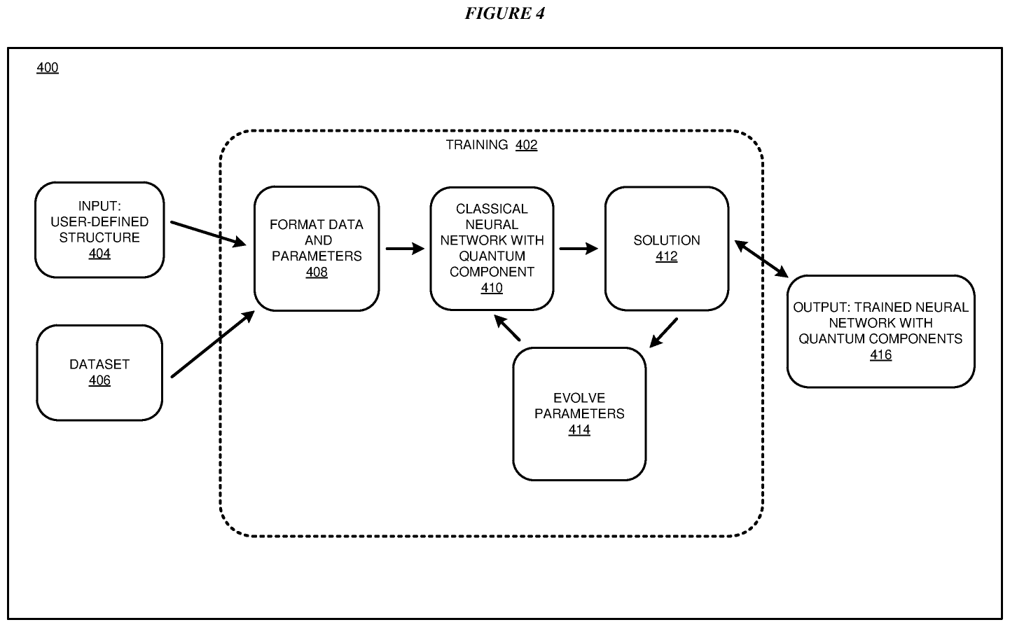

With reference to FIG. 4, this figure depicts a block diagram of an example process 400 for training a hybrid classical-quantum neural network in accordance with an illustrative embodiment. Process 400 includes a training operation 402 configured to receive an input including a user-defined structure 404 for the neural network, and a dataset 406 including training data for training the neural network. In particular embodiments, the user-defined structure for the neural network includes a number of layers, a neuron population in each layer, and activation functions for the neural network. In one or more embodiments, one or more portions of training operation 402 are implemented using an application within a classical processing system such as application 105 of FIG. 1.

Training operation 402 includes a format data and parameters component 406 in which the user-defined structure in which user-defined structure 404 and dataset 406 are formatted to generate one or more parameters for the neural network. A hybrid classical neural network with a quantum component 410 receives the training data and trains the neural network to produce a solution 412. In the illustrated embodiment, hybrid classical neural network with a quantum component 410 includes one or more quantum kernel components that have replaced classical neural network as described herein with respect to one or more embodiments.

In the illustrated embodiment, solution 412 is evaluated to determine if classical neural network with quantum component 410 provides results of acceptable quality. If an acceptable quality has not been achieved, training operations 402 evolve parameters of the neural network which may include further substituting a classical component of the neural network with a quantum component and/or substituting a quantum component with a classical component in order to improve accuracy and/or efficiency. Training operations 402 then continue until acceptable results are achieved. Once acceptable results are achieved, a trained neural network with quantum components is output.

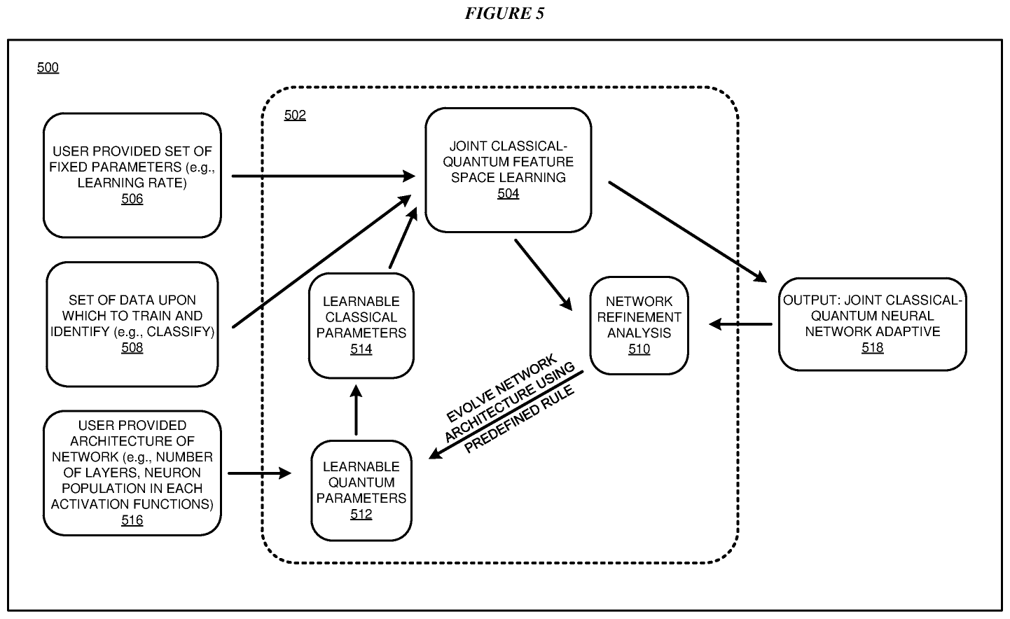

With reference to FIG. 5, this figure depicts a block diagram of an adaptive learning process 500 for a classical neural network with a quantum component in accordance with an illustrative embodiment. In the embodiment, an application 502 executed by a classical processor initiates a joint classical-quantum feature space learning procedure 504 upon a neural network. Joint classical-quantum feature space learning procedure 504 receives a user provided set of fixed parameters 506 associated with the neural network such as a learning rate for the neural network and a set of data upon which to train and/or identify 508 (e.g., classify). Application 502 further receives a user provided architecture of the neural network such as a number of layers of the neural network, a neuron population in each layer, and activation functions of the neural network. In an embodiment, application 502 is an example of application 105 of FIG. 1.

Joint classical-quantum feature space learning procedure 504 receives the training data and trains the neural network, or alternately receives data and classifies the data using the trained neural network. A network refinement analysis procedure 510 evaluates the neural network to determine whether to replace a classical network component with a quantum kernel component to evolve the neural network architecture using a predefined rule. Application 502 further determines learnable quantum parameters 512 associated with quantum kernel components of the neural network and learnable classical parameters 514 associated with classical components of the neural network and provides each to the neural network.

As a result of the adaptive learning procedure of the neural network, application 504 outputs a joint classical-quantum neural network having classical components and one or more quantum kernel components that have replaced certain other classical components of the neural network.

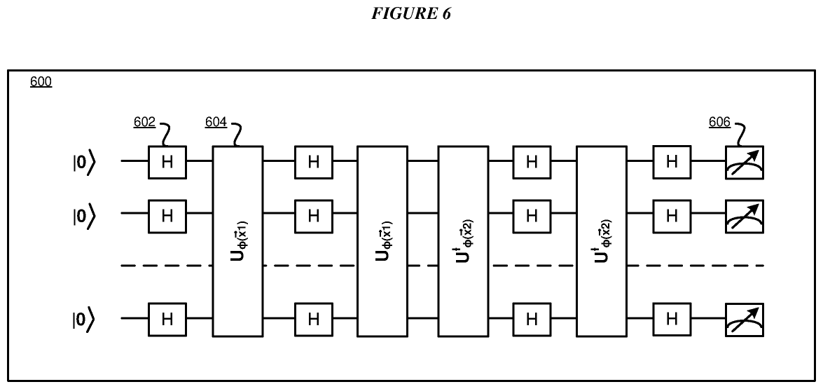

With reference to FIG. 6, this figure depicts a block diagram of an example quantum SVM gate circuitry 600 for implementing a quantum kernel component in accordance with an illustrative embodiment. Quantum SVM gate circuitry 600 represents an example of a particular component to perform a quantum SVM implementation. In the example, quantum SVM gate circuitry 600 includes single q-bit gates, in this example Hadamard (H) gates 602, and multi-qubit entangling unitary operations 604. Although the illustrated embodiments utilize H gates 602, in other examples other types of gates may be used. In the illustrated embodiment, the multi-qubit entangling unitary operations 604 are of the form:

UΦ(\vec{x})=exp(iΣ_{sε[n]}øs(\vec{x})Π_{iεS}Σᵢ)

where øₛ

is a scalar map of the classical data associated with the classical component of the neural network and Z is a Pauli operator.

Quantum SVM gate circuitry 600 further includes measurement circuitry 606 to measure outputs of the operations. In the illustrated embodiment, quantum SVM gate circuitry 600 calculates an inner product of two data points in a mapped feature space.

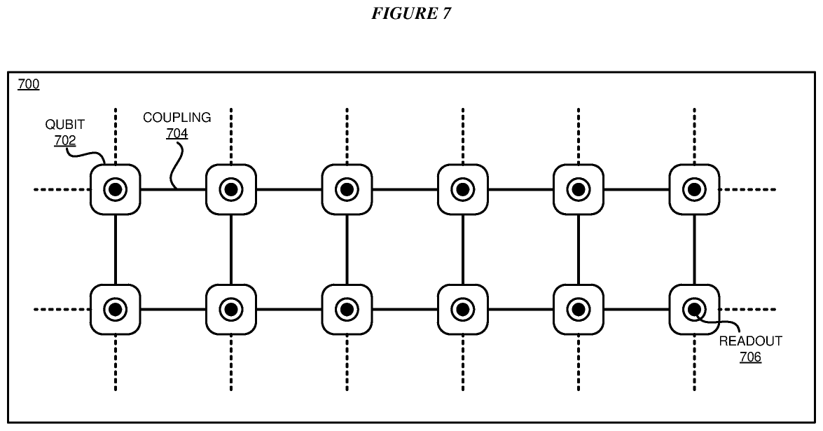

With reference to FIG. 7, this figure depicts a simplified diagram of an example quantum processor layout 700 in accordance with an illustrative embodiment. Quantum processor layout 700 includes twelve qubits 702, sixteen coupling elements 704, and twelve readout apparatus 706. In the illustrated embodiments, qubits 702 are arranged in a 6×2 array which coupling elements 704 coupling neighboring qubits 702. Qubits 702 are provided with the capability to be initialized, coupled, and measured to determine a quantum state of each qubit. Coupling elements 704 provide qubit-qubit interactions to create entanglement. Each of readout apparatus 706 are associated with a corresponding qubit 702 and are configured to readout a measurement of the associated qubit 702. In accordance with one or more embodiment, the quantum processor illustrated by quantum processor layout 700 is configured to implement a quantum kernel component for replacing one or more corresponding classical components of a neural network as described with respect to certain embodiments.

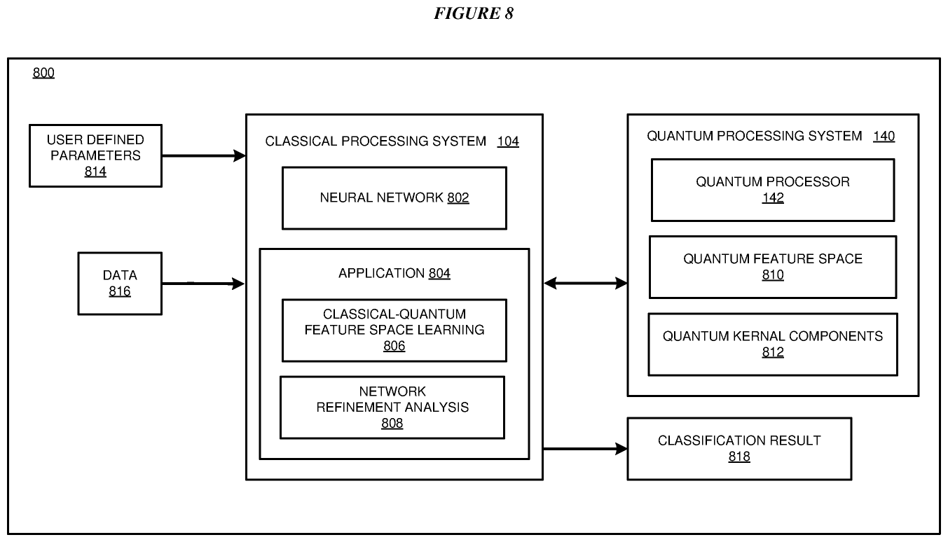

With reference to FIG. 8, this figure depicts a block diagram of an example configuration 800 for implementing a classical neural network with selective quantum computing kernel components in accordance with an illustrative embodiment. The example embodiment includes classical processing system 104 and quantum processing system 140. Classical processing system 104 includes a neural network 802, and an application 804. In a particular embodiment, application 802 is an example of application 105 of FIG. 1. Application 804 includes a classical-quantum feature space learning component 806 and a network refinement analysis component 808. Quantum processing system 140 includes a quantum processor 142, a quantum feature space 810, and quantum kernel components 812.

In the embodiment, application 804 is configured to received user defined parameters 814 and data 816. In one or more embodiments, user defined parameters 814 include parameters of neural network 802 such as a learning rate, number of layers, neuron population in each layer, and activation functions associated with neural network 802. In one or more embodiments data 816 includes one or more of training data for neural network 802 or input data to be classified by neural network 802.

Classical-quantum feature space learning component 806 is configured to receives the training data and train neural network 802, or alternately receive input data and classify the input data using the trained neural network 802. Network refinement analysis component 808 is configured to evaluate neural network 802 to determine whether to replace one or more classical network components of neural network 802 with a quantum kernel component. Responsive to determining by application 804 to replace one or more classical network components of neural network 802 with one or more quantum kernel components, quantum processor 142 constructs one or more quantum kernel components 812 to implement a quantum feature space 810 that is equivalent to the feature space implemented by the one or more classical network components. Application 804 is further configured to replace the one or more classical components within neural network 802 with the one or more quantum kernel components 812 implemented by quantum processor 142 to implement a joint classical-quantum neural network.

Application 804 is further configured to receive input data which is desired to be classified and classical processing system 104 applies joint classical-quantum neural network 802 to the input data to classify the input data and output a classification result 816 indicative of a classification of the input data.

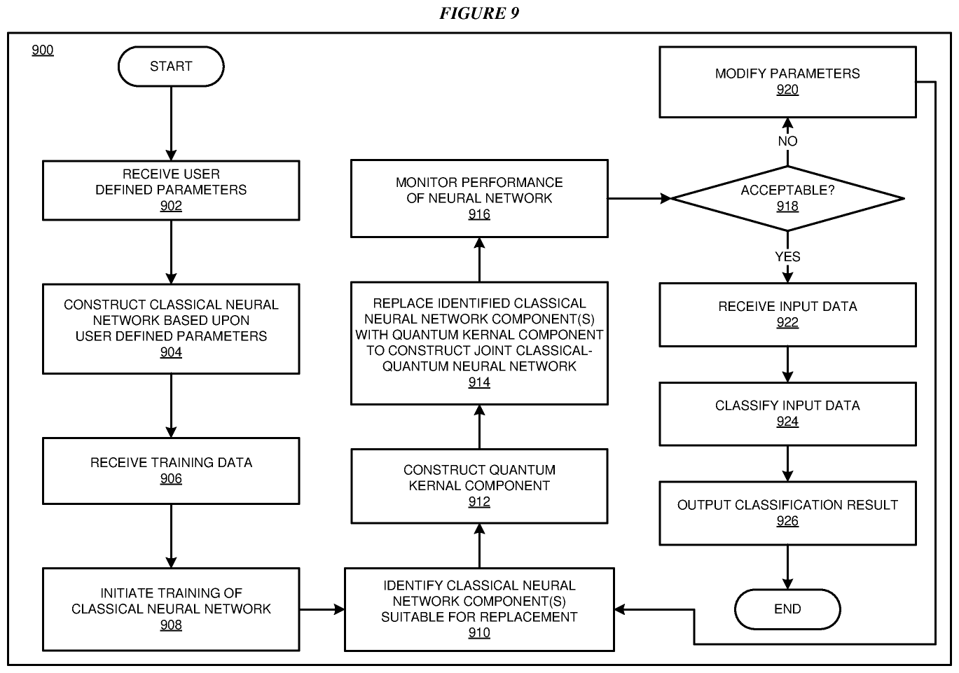

With reference to FIG. 9, this figure depicts a flowchart of an example process 900 for implementing a classical neural network with selective quantum computing kernel components in accordance with an illustrative embodiment. In block 902, classical processor 122 receives one or more user defined parameters. In one or more embodiments, user defined parameters 814 include parameters of a classical neural network such as a learning rate, number of layers, neuron population in each layer, and activation functions associated with the classical neural network. In block 904, classical processor 122 constructs a classical neural network based upon the user defined parameters.

In block 906, classical processor 122 receives training data. In one or more embodiments, the training data includes training objects associated with one or more classification categories. In particular embodiments, an object within the training data is represented by one or more vectors. In block 908, classical processor 122 initiates training of the classical neural network using the training data.

In block 910, classical processor 122 identifies one or more classical neural network components of the neural network that are suitable for replacement by one or more quantum kernel components. In an embodiment, analysis of information flow and/or sensitivity are used for characterization/identification of classical network components of the neural network whose feature space can benefit from a quantum feature space enhancement. In particular embodiments, classical processor 122 may determine that classical network components that are relatively insensitive to varying input signals are candidates for replacement by a quantum kernel component.

In particular embodiments, terminal classical components of the classical neural network are analyzed differently than non-terminal components. In a particular embodiment, for terminal nodes/components of the neural network, classical processor 122 monitors the response (e.g., changes in which class is chosen) of a classical neural network node to “noise” such as random noise or actual samples that are close to one another using a particular vector-based metric of distance.

In another particular embodiment, non-terminal nodes are monitored at a particular depth D in the network and noise is introduced via a different sample to determine that the node is “not sensitive enough.” Further, classical processor 122 may consider upstream data and monitor the differences in the signals the node receives. A situation may exist that there are nodes “in front of” the node in the neural network that are damping out the difference and that this node/component has no opportunity to respond differently since it is receiving the same signal.

In view of this, classical processor 122 may determine by tracking the propagation of the signal from input or from traversing backwards in the neural network level-by-level from the component at depth D) that the node(s) that are tamping out the sensitivity and look at the nodes as a new candidate(s) for replacement. If the component at depth D is receiving a different signal, but the difference does not exceed a particular threshold, noise may be added to the signals incoming to the node. In other particular embodiments, classical processor 112 may monitor the backpropagation in the neural network to determine that a component is insensitive to feedback from training.

In block 912, quantum processor 142 constructs a quantum kernel component implemented by quantum processor 142 to replace the one or more identified classical neural network components. In a particular embodiment, the feature space of the quantum kernel component is equivalent to the classical feature space of the classical neural network components to be replaced. In block 914, classical processor 122 replaces the identified classical neural network components with the quantum kernel component to construct a joint classical-quantum neural network.

In block 916, classical processor 122 monitors the performance of the joint classical-quantum neural network to determine a quality level of the classification results of the joint classical-quantum neural network. In block 918, classical processor 122 determines whether the quality level of the joint classical-quantum neural network is at an acceptable threshold value.

If the quality level of the classification results of the joint classical-quantum neural network are not at the acceptable threshold value, process 900 continues to block 920. In block 920, classical processor 122 modifies one or more of the parameters of the neural network and process 900 returns to block 910.

If the quality level of the classification results of the joint classical-quantum neural network are at the acceptable threshold value, process 900 continues to block 922. In block 922, classical processor 122 receives input data to be classified. In block 924, classical processor 122 determines a classification of the input data using the joint classical-quantum neural network. In block 926, classical processor 122 outputs a classification result indicative of the determined classification of the input data. Process 900 then ends.

Thus, a computer implemented method, system or apparatus, and computer program product are provided in the illustrative embodiments for implementing a classical neural network with selective quantum computing kernel components and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, including but not limited to computer-readable storage devices as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for implementing a hybrid classical-quantum neural network, the method comprising:
constructing, by at least a first processor, a neural network for classification of input data, the neural network including a plurality of neural network components;
initiating, by the at least a first processor, training of the neural network using training data;
identifying, by the at least a first processor, one or more of the plurality of neural network components for replacement;
constructing, by a quantum processor, a quantum component corresponding to the one or more network components; and
replacing the one or more identified neural network components of the neural network with the quantum component to construct a hybrid classical-quantum neural network.

2. The method of claim 1, further comprising:
receiving one or more user defined parameters, wherein the neural network is constructed based upon the one or more user defined parameters.

3. The method of claim 1, wherein the quantum component comprises a quantum kernel component.

4. The method of claim 1, wherein the quantum kernel component implements a quantum feature space that is equivalent to or provides improved classification performance over a feature space associated with the one or more identified neural network components.

5. The method of claim 1, wherein the one or more neural network components are identified based upon a sensitivity of the one or more neural network components to input data during training.

6. The method of claim 1, wherein the one or more neural network components are identified based upon a firing pattern during inference.

7. The method of claim 1, further comprising:
monitoring a performance of the hybrid classical-quantum neural network to determine a quality level of classification results of the hybrid classical-quantum neural network.

8. The method of claim 7, further comprising:
identifying, responsive to determining that the quality level does not meet a threshold value, one or more other neural network components for replacement.

9. The method of claim 1, further comprising:
receiving input data;
classifying the input data using the hybrid classical-quantum neural network; and
outputting a classification result indicative of the determined classification of the input data.

10. The method of claim 1, wherein the at least a first processor comprises a classical processor.

11. The method of claim 1, wherein the neural network comprises a classical neural network.

12. A computer usable program product comprising one or more computer-readable storage devices, and program instructions stored on at least one of the one or more storage devices, the stored program instructions comprising:
program instructions to construct, by at least a first processor, a neural network for classification of input data, the neural network including a plurality of neural network components;
program instructions to initiate, by the at least a first processor, training of the neural network using training data;
program instructions to identify, by the at least a first processor, one or more of the plurality of neural network components for replacement;
program instructions to construct, by a quantum processor, a quantum component corresponding to the one or more network components; and
program instructions to replace the one or more identified neural network components of the neural network with the quantum component to construct a hybrid classical-quantum neural network.

13. The computer usable program product of claim 12, further comprising:
program instructions to receive one or more user defined parameters, wherein the neural network is constructed based upon the one or more user defined parameters.

14. The computer usable program product of claim 12, wherein the quantum component comprises a quantum kernel component.

15. The computer usable program product of claim 12, wherein the quantum kernel component implements a quantum feature space that is equivalent to or provides improved classification performance over a feature space associated with the one or more identified neural network components.

16. The computer usable program product of claim 12, wherein the one or more neural network components are identified based upon a sensitivity of the one or more neural network components to input data during training.

17. The computer usable program product of claim 12, wherein the one or more neural network components are identified based upon a firing pattern during inference.

18. The computer usable program product of claim 12, wherein the computer usable code is stored in a computer readable storage device in a data processing system, and wherein the computer usable code is transferred over a network from a remote data processing system.

19. The computer usable program product of claim 12, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to construct, by at least a first processor, a neural network for classification of input data, the neural network including a plurality of neural network components;
program instructions to initiate, by the at least a first processor, training of the neural network using training data;
program instructions to identify, by the at least a first processor, one or more of the plurality of neural network components for replacement;
program instructions to construct, by a quantum processor, a quantum component corresponding to the one or more network components; and
program instructions to replace the one or more identified neural network components of the neural network with the quantum component to construct a hybrid classical-quantum neural network.
